(19) United States
(12) Patent Application Publication
(10) Pub. No.: US 2026/0276155 A1
(43) Pub. Date: Sep. 17, 2026

(54) END BOSS SEALING

(71) Applicant: Worthington Industries Poland SP z.o.o., Slupsk (PL)

(72) Inventors: Oliver Baer, Unna (DE); Christian Rasche, Witten (DE)

(21) Appl. No.: 19/674,378

(22) Filed: May 12, 2026

Related U.S. Application Data
(63) Continuation of application No. 18/552,205, filed on Mar. 14, 2022.

(30) Foreign Application Priority Data
Mar. 23, 2021 (DE) 102021107165.8

(51) Int. Cl. F17C 13/04; F17C 1/16

(52) U.S. Cl. CPC F17C 13/04; F17C 1/16; F17C 2201/0109; F17C 2201/056; F17C 2203/0604; F17C 2203/0619; F17C 2203/0673; F17C 2205/0305; F17C 2209/2127; F17C 2209/2154; F17C 2221/012; F17C 2270/0168

(57) ABSTRACT

The invention relates to a composite pressure vessel (1) with a liner (2) made of plastic, at least one end boss (4) arranged in the region of the opening of the pressure vessel (1) and an outer layer (3) of a fiber composite material. The end boss (4) has a through hole (5) and is used for connecting a valve. The liner (2) has an axial tubular neck portion (14) with a mouth at its axial end, which extends into the end boss (4) and is provided on its outer side with an external thread (15) and a thread-free region. The external thread is screwed into an internal thread of the through hole (5) of the end boss (4).

To optimize sealing, an inner wall of the end boss (4) in contact with the thread-free region of the neck portion (14) has at least two annular grooves (10, 11) arranged at an axial distance from one another, wherein two sealing rings (16, 17) are arranged in the annular grooves (10, 11). A first sealing ring (16) is made of a first material that seals at low temperatures, and a second sealing ring (17) is made of a second material that has low gas permeability.

### TECHNICAL FIELD

The system described herein relates to a composite pressure vessel for gaseous media, having a liner made of plastic, and at least one neck piece or end boss arranged in the region of the opening of the pressure vessel.

### BACKGROUND

Neck pieces of composite pressure vessels are referred to in practice as end bosses. Such a composite pressure vessel is known, for example, from publication WO99/27293 A2. The neck portion of the liner with the mouth has an external thread which is screwed into an internal thread of the inner wall of the end boss. The end portion of the end boss facing the liner has a flat collar disposed between the liner and the reinforcing outer layer. Using a clamping ring, the neck portion of the liner is pressed into the inner wall, as illustrated in, for example, WO99/27293 A2. Between the external thread and the mouth at the face of the liner, there is a sealing ring arranged in a groove of the end boss on the outside of the end boss. A second sealing ring is arranged in the area of the flat collar between the liner and the end boss. This second sealing ring has no significant sealing effect. Even the first sealing ring near the mouth at the face of the liner is not always sufficient to reliably seal the high pressures inside the liner against the environment over an entire specified temperature range.

Similar configurations are known from US 2017/0268724 A1 and DE 10 2010 018 700 A1. The latter publication has sealing rings on the inside and outside near the front end of the tubular mouth. DE 10 2009 049 948 B4 describes an additional insert to effect the seal between the liner and the end boss so that there is no sealing ring directly between the liner and the end boss. In US 2010/163565 A1, too, sealing is achieved by additional components beyond the front end of the liner.

In the publications DE 11 2007 002 491 B4, US 2001/0255940 A1 and US 2007/0111579 A1, the end bosses have a tubular projection projecting into the interior of the pressure vessel, and the liners extend along the outside of this projection toward the center of the vessel, where the liners are sealed.

### SUMMARY

It is desirable to provide a composite pressure vessel that is optimally sealed with a simple design.

According to the system described herein, a composite pressure vessel that is optimally sealed with a simple design is in which the inner wall of the end boss, which is in contact with the thread-free region of the neck portion, has at least two annular grooves arranged at an axial distance from one another, in which annular grooves two sealing rings are arranged so that the thread-free region of the neck portion is pressed against the sealing rings by the internal pressure, a first sealing ring consisting of a first material which seals at low temperatures and a second sealing ring consisting of a second material which has a low gas permeability.

In other words, the tubular mouth of the liner is turned outwards, i.e., the tubular mouth of the liner protrudes outwards. The tubular mouth of the liner is not compressed or jammed but simply pressed outward in a radial direction by the internal pressure in the vessel. On the outside of the mouth, two sealing rings are arranged at an axial distance from each other, which lie in two annular grooves provided in the cylindrical inner wall of the end boss. This ensures that the sealing rings are pressed radially against the inner wall of the end boss with the same force by the pressure acting inside the neck portion of the liner. The two different materials of the sealing rings ensure that the high performance requirements for sealing such a pressure vessel are met. Tightness must be ensured over a wide temperature range, which extends from −60° C. to +120° C. For this reason, a first material is selected for the first sealing ring that exhibits excellent sealing properties even at very low temperatures below −30° C., preferably at temperatures close to −60° C. An ethylene propylene diene rubber (EPDM) is such a material, which seals reliably even at the lowest temperatures.

Furthermore, an almost absolute tightness must be achieved. Particularly when using a composite pressure tank as a hydrogen tank for vehicles, it must be avoided that the tank is emptied after a few days or even weeks due to diffusion of the stored hydrogen into the ambient air and the vehicle is therefore no longer roadworthy. The high tightness of the seal is achieved by the second sealing ring, which is made of a second material with a low gas permeability. This second material can be a polyurethane.

The complete sealing using the two sealing rings eliminates the need for a collar on the end boss, which is located between the liner and the reinforcing outer layer. Such a collar is not required for sealing the liner against the environment.

In practice, the end boss may have a sealing edge that presses into the material of the liner. The sealing edge provides a further increase in the sealing effect. No additional components are required to increase the sealing effect. It is also not necessary to guide the liner back into the interior of the vessel to achieve an effective seal.

The chosen design results in an optimum seal between the interior of the liner, in which the pressurized gas, in a practical embodiment hydrogen at a pressure of 400 bar and above, is located. The high gas pressure in the plastic liner causes the liner to expand in all directions. Both the two sealing rings and the sealing edge are arranged so that, due to the internal pressure, the wall of the liner is pressed against the sealing elements, thereby achieving a high sealing effect.

In this regard, in practice, the wall thickness of the neck portion of the liner may be substantially constant in the thread-free region. The wall thickness of the liner may be substantially the same in all areas because the liner has no special mechanical fasteners or backbends. The arrangement of the two sealing rings in the cylindrical inner wall of the end boss ensures that the liner is sealed against the end boss and thus against the valve that can be connected to the end boss. The same internal radial pressure of the vessel acts on both sealing rings, expanding and radially widening the tubular neck portion of the liner.

In particular, in practice, the end boss may have a radially inwardly projecting shoulder face facing the annular end face of the mouth of the liner, with the sealing edge projecting axially from the shoulder face and pressing into the annular end face of the mouth. Such an annular sealing edge, which is pressed against and into the end face of the mouth when the internal pressure of the vessel is high, has the effect of significantly increasing the sealing of the liner against the environment of the end boss. The annular sealing edge also stabilizes the mouth area of the liner. Over the life cycle of a pressurized gas vessel with frequent changes in vessel internal pressure and wide temperature fluctuations, it has been observed that the mouth area of the liner deforms inward and lifts away from the inner wall of the end boss. Due to the annular sealing edge penetrating axially into the annular end face of the mouth, the mouth is mechanically fixed and cannot deform freely.

### BRIEF DESCRIPTION OF THE DRAWINGS

Further practical embodiments and advantages of the system described herein are described below in connection with the drawings.

FIG. 1 shows a longitudinal section of a composite pressure vessel designed according to the system described herein.

FIG. 2 shows an upper end boss of a pressure vessel in longitudinal section.

FIG. 3 shows an enlarged view of detail A of FIG. 2 with a sealing arrangement in an end boss.

FIG. 4 shows a representation of an end boss corresponding to FIG. 2 with sealing rings therein and a neck portion of a liner.

### DETAILED DESCRIPTION

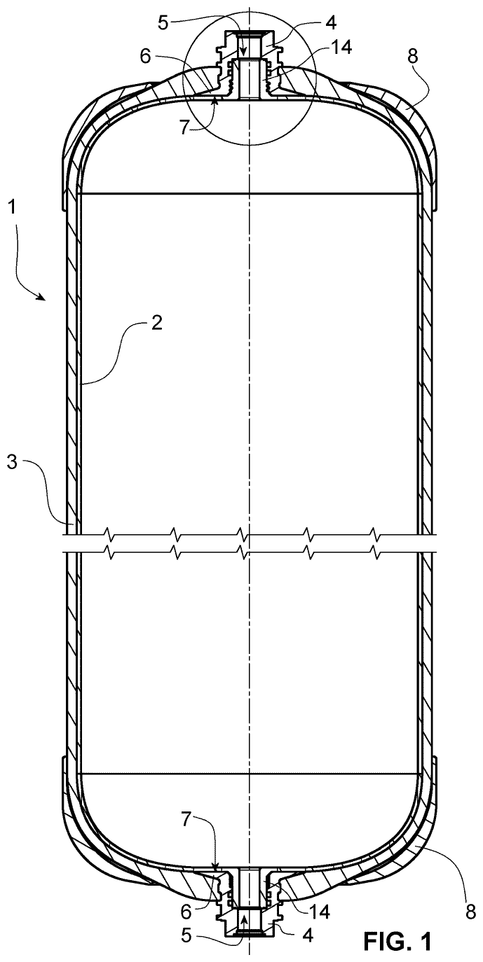

FIG. 1 shows a longitudinal section of a composite pressure vessel 1 described above. The composite pressure vessel 1 includes a plastic liner 2 produced by blow molding or by rotational sintering or thermoforming. The liner 2 is reinforced by an outer layer 3 applied from the outside. In practice, the outer layer 3 may be made of a composite of plastic resin and a fiber reinforcement such as carbon, aramid, glass, boron, Al₂O₃ fibers or mixtures (hybrid yarns) thereof embedded in a matrix of duromers, e.g., epoxy or phenolic resins, etc., or in thermoplastics, e.g., PA 12, PA6, PP, etc. The fibers can be applied to the liner by blow molding or rotational sintering or thermoforming. The fibers can be wound directly onto the liner or the outer layer 3 can be formed from so-called organo-sheets, i.e., fiber tapes bound in a plastic matrix, the fiber tapes being preferably interwoven.

In the fiber composite of the outer layer 3, the fibers can be applied both in the axial and tangential direction of the vessel or also in the diagonal direction. Using the axial winding, the pole caps of the liner 2 are also uniformly wound. Before, alternately with or after winding of the pole caps, the deposition of the fiber reinforcement body can be executed, exclusively tangentially or in the circumferential direction of the cylindrical vessel part. The wall thickness proportions of tangential wrapping and axial wrapping depend on the outer diameter of the plastic liner 2, the strength of the fiber reinforcement body, the wrapping angles, etc.

The composite pressure vessel 1 has openings at both axial ends, each of which is closed by an end boss 4. In the embodiment shown in FIG. 1, identical end bosses 4 with through holes 5 are arranged at both ends so that gas can be withdrawn from the composite pressure vessel 1 or refueling is possible at both ends. However, embodiments are also common in which an end boss does not have a through hole at one end, so that gas withdrawal and refueling can only take place at one axial end. One such embodiment is shown in publication WO99/27293 A2.

In a known manner, both end bosses 4 have a frustoconical collar 6 with a side 7 facing the center of the vessel that contacts the liner 2. However, since the collar 6 does not contribute to sealing the liner 2 in the embodiment described herein, the collar 6 can also be dispensed with if required and the end boss can essentially consist only of a tubular component. Both ends in the longitudinal direction of the composite pressure vessel 1 are covered with an impact-absorbing layer 8, which covers and protects at least the radially outer regions of the outer layer 3 made of fiber composite material. Preferably, the layer 8 is made of polyurethane foam.

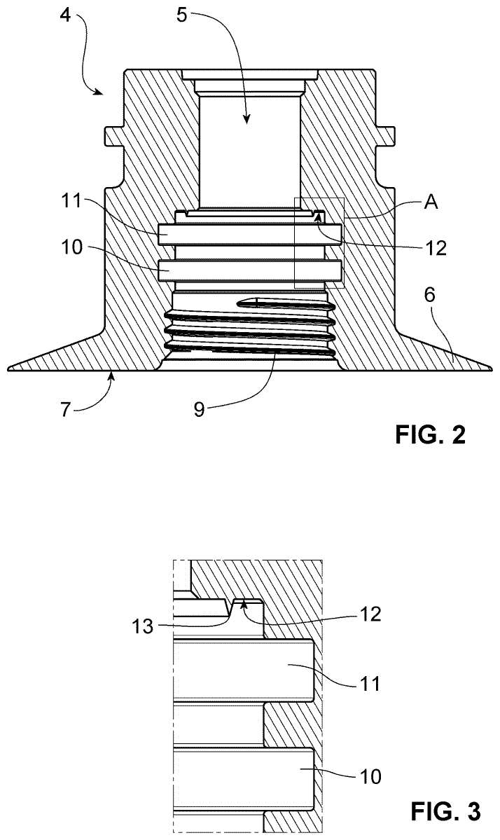

FIG. 2 shows an enlarged view of the end boss 4 in longitudinal section, and FIG. 3 shows a further enlarged view of detail A from FIG. 2. The through hole 5 is used to fill and remove liquid or gaseous medium, for example hydrogen. In the upper area in FIG. 2, a valve can be connected to the end boss 4 by which the filling and withdrawal of the medium is controlled. The lower surface 7 of the frustoconical collar 6 is intended to rest against the upper surface of the liner 2 (FIG. 1), the neck portion of which is screwed into an internal thread 9 in the lower region of the through hole 5. Above the internal thread 9 in the thread-free region of the through hole 5 are two annular grooves 10, 11 which are intended to receive sealing rings.

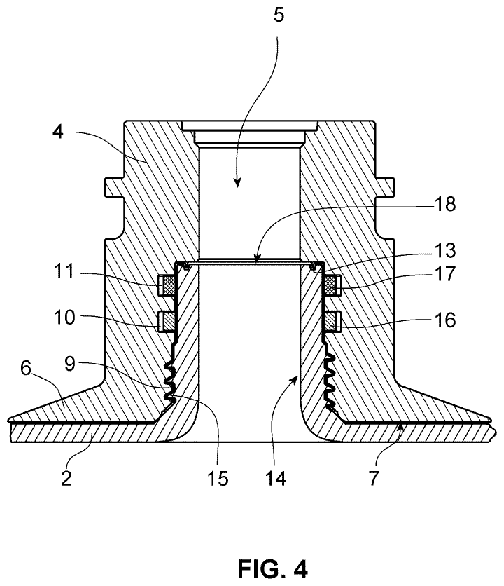

Above the upper annular groove 11 is a radial shoulder face 12 which projects inwardly and forms a contact surface for the annular end face of the mouth of the liner 2 (see FIG. 4). From the radially inwardly projecting annular shoulder face 12, an annular sealing edge 13 projects in the axial direction of the vessel toward the center of the vessel.

FIG. 4 shows a longitudinal section of the end boss 4 corresponding to FIG. 2 with the liner 2 inserted therein. It can be seen that the liner 2 has a tubular neck portion 14, on the outside of which an external thread 15 is arranged in the lower region. This external thread 15 is screwed into the thread 9 of the end boss 4. In FIG. 4, above the external thread 15, a thread-free region of the neck portion 14 adjoins, which seals the interior of the liner 2. The outside of the thread-free region of the liner 2 cooperates with two sealing rings 16, 17 arranged in the annular grooves 10, 11. Further, the annular sealing edge 13 presses into the annular end face 18 of the neck portion 14. The annular sealing edge 13 thus provides additional sealing of the interior of the neck portion 14 from the surroundings. Furthermore, the annular sealing edge 13 fixes the end face 18 of the neck portion 14 in position and thus counteracts deformation of the end face 18 of the neck portion 14.

The sealing rings 16 and 17 have different materials to meet the various requirements for sealing the liner 2. The first sealing ring 16 is made of an ethylene propylene diene rubber (EPDM), which ensures excellent sealing properties at temperatures down to −60° C. The second sealing ring 17 is made of a polyurethane that has extremely low gas permeability and thus ensures that gas stored in the pressurized gas vessel remains in the pressurized gas vessel over a longer period of time and does not escape from the pressurized gas vessel to an inadmissibly high extent by diffusion.

The features of the invention disclosed in the present description, in the drawings as well as in the claims may be essential, both individually and in any combination, for the realization of the invention in various embodiments. The invention is not limited to the embodiments described. The invention may be varied within the scope of the claims and with due regard to the knowledge of the person skilled in the art.

1. A composite pressure vessel for gaseous media, comprising:
a liner made of plastic; and
at least one end boss arranged in a region of an opening of the pressure vessel and having an outer layer of a fiber composite material reinforcing the liner, the at least one end boss having a through hole and being designed for connection of a valve, wherein the liner includes a tubular neck portion having a mouth at an axial end thereof and extending into the at least one end boss in a direction of an axis of the pressure vessel, and being provided on an outer side thereof with an external thread and an adjoining thread-free region, and wherein an internal thread is arranged in the through hole of the at least one end boss, into which the external thread of the neck portion of the liner is screwed, wherein an inner wall of the at least one end boss in contact with the thread-free region of the neck portion has at least two annular grooves arranged at an axial distance from one another, the grooves each having one of two sealing rings are arranged therein so that the thread-free region of the neck portion is pressed against the sealing rings by internal pressure, and wherein one of the sealing rings is made of a first material which seals at low temperatures, and an other of the sealing rings made of a second material which has a low gas permeability.

2. The composite pressure vessel according to claim 1, wherein the first material is an ethylene-propylene-diene rubber and/or the second material is a polyurethane.

3. The composite pressure vessel according to claim 1, wherein the at least one end boss has a sealing edge which presses into the material of the liner.

4. The composite pressure vessel according to claim 3, wherein the wall thickness of the at least one end boss of the liner is substantially constant in the thread-free region.

5. The composite pressure vessel according to claim 3, wherein the at least one end boss has a shoulder face projecting radially inwardly and facing an annular end face of the mouth of the liner, wherein the sealing edge projects axially from the shoulder face and presses into the annular end face of the mouth.

6. The composite pressure vessel according to claim 2, wherein the at least one end boss has a sealing edge which presses into the material of the liner.

7. The composite pressure vessel according to claim 6, wherein the wall thickness of the at least one end boss of the liner is substantially constant in the thread-free region.

8. The composite pressure vessel according to claim 4, wherein the at least one end boss has a shoulder face-projecting radially inwardly and facing an annular end face of the mouth of the liner, wherein the sealing edge projects axially from the shoulder face and presses into the annular end face of the mouth.

9. The composite pressure vessel according to claim 6, wherein the at least one end boss has a shoulder face-projecting radially inwardly and facing an annular end face of the mouth of the liner, wherein the sealing edge projects axially from the shoulder face and presses into the annular end face of the mouth.

10. The composite pressure vessel according to claim 7, wherein the at least one end boss has a shoulder face-projecting radially inwardly and facing an annular end face of the mouth of the liner, wherein the sealing edge projects axially from the shoulder face and presses into the annular end face of the mouth.
